(19) United States
(12) Patent Application Publication
(10) Pub. No.: US 2009/0112431 A1
(43) Pub. Date: Apr. 30, 2009

(54) Hydraulic System For An All-Wheel Drive System And Method Of Controlling Said Hydraulic System

(76) Inventor: Per-Olof Davidsson, Limhamn (SE)

Correspondence Address: ST. ONGE STEWARD JOHNSTON & REENS, LLC, 986 BEDFORD STREET, STAMFORD, CT, 06905-5619, US

(21) Appl. No.: 12/348,608

(22) Filed: Jan. 5, 2009

Related U.S. Application Data
(63) Continuation of application No. PCT/EP2006/063890, filed on Jul. 5, 2006.

(51) Int. Cl. G06F 19/00

(52) U.S. Cl. 701/69

(57) ABSTRACT

Method of controlling a hydraulic system for an all-wheel drive system, including an electric hydraulic pump, a control valve for directing hydraulic fluid to a load, and an accumulator in fluid communication with the pump and the valve. The method includes the steps of estimating a negative hydraulic-fluid leakage flow out of the accumulator. Using a predetermined model, estimating a negative hydraulic-fluid work flow through the valve, and estimating a first positive fluid flow from the pump into the accumulator. The above estimated negative hydraulic-fluid leakage flow, negative hydraulic-fluid work flow and positive fluid flow are added to a total flow communicating with the accumulator, and a value is obtained of the volume of the hydraulic fluid in the accumulator from the total flow communicating with the accumulator for controlling an operation mode of the pump.

### CROSS-REFERENCE TO RELATED APPLICATIONS

The present application is a continuation of pending International patent application PCT/EP2006/063890 filed on Jul. 5, 2006 which designates the United States, the content of which is incorporated herein by reference.

### FIELD OF THE INVENTION

The present invention relates to a hydraulic system for an all-wheel drive system for road and/or off-road vehicles. It also relates to a method of controlling said hydraulic system and a computer-readable medium with a program for performing the above method.

### BACKGROUND OF THE INVENTION

Hydraulic systems for all-wheel drive applications in modern automotive vehicles are equipped with hydraulic components, for controlling and powering parts of the all-wheel drive system, such as wet clutches and differential brakes. Normal hydraulic components are a hydraulic pump and control valves, and the function of these components is very critical for the vehicle to behave in a safe manner. The all-wheel drive system is thus normally provided with safety features, for monitoring the system, such as pressure transducers, pressure switches, and position indicators. These sensors are very costly, however, and increase the total cost of the system significantly.

### SUMMARY OF THE INVENTION

It is an object of the present invention to provide a hydraulic system for all-wheel drive applications that is as safe as previous systems but which is much cheaper to manufacture since it contains fewer parts. This is achieved by replacing the measurement of parameters by sensors of prior art systems with a method of monitoring and controlling the hydraulic system of the vehicle, where the fill-ratio of an accumulator is estimated by using readily available control signals. The positive flow to the accumulator is estimated by monitoring the supply voltage and current to the hydraulic pump. The negative flow from the accumulator is estimated from the control signal from an electronic control unit (ECU) to a control valve (work flow) and from predetermined leakage flow through valves, which e.g. depends on the hydraulic pressure in the system. The fill-ratio of the accumulator is estimated as the sum of the above positive and negative flows.

A reference value of the fluid level in the accumulator can be obtained by monitoring the pump current, which changes markedly when the accumulator is full.

The accumulator may be fitted with an overflow valve, which opens when the accumulator is full, in order to more easily detect a change in the pump current when the accumulator is full.

### BRIEF DESCRIPTION OF THE DRAWINGS

The all-wheel drive system according to the invention is more easily understood by reading the below detailed description with references to the drawings, in which

FIG. 1 is a schematical view of a typical hydraulic circuit for an all-wheel drive system according to the invention,

FIG. 2 is a flowchart showing the method steps for controlling the hydraulic circuit of FIG. 1, and

FIG. 3 is a graph showing the electric hydraulic pump drive current as a function of volume in the accumulator, for different designs of the accumulator.

### DETAILED DESCRIPTION OF THE INVENTION

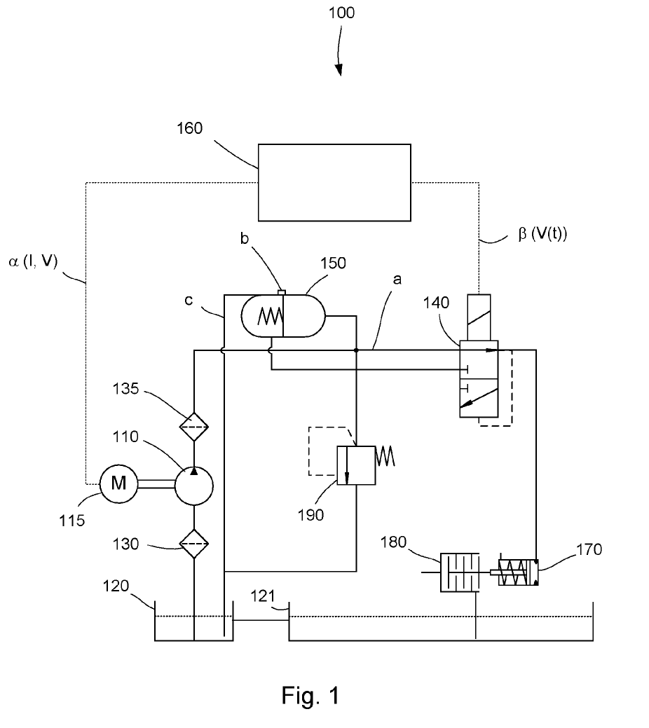

The present invention relates to a hydraulic system 100 for an all-wheel drive system, which uses a control method for operating electric hydraulic pump. The hydraulic system according to the invention as shown in FIG. 1 comprises a relatively small hydraulic pump 110, which is driven by an electric motor 115. The pump draws hydraulic fluid from a reservoir 120 through a sieve 130 and then delivers pressurized hydraulic fluid to a valve 140, such as a pulse-width modulated (PWM) valve, via a filter 135. A channel a leading from the pump 110 to the valve 140 is connected to an accumulator 150, which accommodates a portion of the pressurized hydraulic fluid. The valve 140 may be controlled by an electronic control unit (ECU) 160, which can receive signals from an associated vehicle, such as vehicle speed, vehicle acceleration, fluid temperatures etc. The valve 140 may direct fluid to a hydraulic cylinder 170, which when supplied pressurized fluid can compress a clutch 180 that can be coupled to a piston of the hydraulic cylinder 170. The system 100 can further be equipped with a pressure relief valve 190 that can be connected between the line a and the reservoir 120. The pressure relief valve 190 may drain off fluid to the reservoir 120, when the pressure in channel a exceeds a certain predetermined pressure. The hydraulic pump 110 or the channel a may be provided with a check valve (not shown), for maintaining the high pressure in the channel a and the accumulator 150. This functionality may also be built into the hydraulic pump 110, or be given by its design.

The accumulator 150 may be equipped with an overflow valve, shown as the channel b in FIG. 1. When the fluid pressure inside the accumulator is sufficiently high, a piston of the accumulator 150 will be pushed past an opening, e.g. in the accumulator wall, which puts channel b in fluid communication between the high-pressure side and the low-pressure side of the accumulator 150, on the other side of the piston. Some hydraulic fluid will flow throw this channel b, until the pressure has dropped and the piston closes off the channel b. The fluid that has leaked to the low-pressure side of the accumulator 150 will be directed to the reservoir 120 via a spillway overflow valve and a line c. The overflow valve thus more or less functions as a pressure relief valve, but is more useful than the standard pressure relief valve 190, as the overflow valve indicates when the accumulator is full. The standard pressure relief valve 190 is still useful, though, since it can protect the hydraulic system if the overflow channel b malfunctions, such as if the accumulator piston gets stuck.

The drain from the control valve 140 is connected to a low-pressure side of the accumulator 150. This is a special feature, which is used for minimizing the change of the fluid level in the reservoir 120. The accumulator is hence always almost full, with hydraulic fluid on both sides or on either side of the piston.

The system 100 may also be provided with an additional valve (not shown) for operating a second hydraulic cylinder coupled to a second actuator (both not shown), e.g. a differential brake. The differential brake may be used for bypassing a differential which otherwise would not transfer any torque to a slipping wheel associated with an axle coupled to the differential. The differential brake may be coupled to a hydraulic cylinder that may be similar to the hydraulic cylinder. Additional components could also be incorporated into the system, as is well known for a person skilled in the art.

The ECU 160 of the all-wheel drive system is configured to send control signals to the electric hydraulic pump 110 and to the control valve 140 and may also receive signals from sensors, which are optionally arranged in the system, if desired. The ECU 160 may also be arranged to measure or estimate the control signals, such as drive currents and voltages that e.g. are sent to the electric hydraulic pump 110 and/or the PWM valve 140. The ECU 160 is hence configured to control the electric motor 115 of the electric hydraulic pump 110 by estimating the fill rate of the accumulator 150, through gathered system information as is explained in more detail below.

The valve 140 may e.g. be a solenoid controlled pressure control valve or a pressure-reducing valve. The clutch 180 and the differential brake may e.g. be wet clutches comprising several separate, axially movable disks, as is well known in the art, or other types that are typical within the art.

During operation of the hydraulic system 100, the ECU 160 sends a control signal a to the pump 110, which draws hydraulic fluid from the reservoir 120 and pressurizes the fluid in channel a. The accumulator 150, connected to channel a, is supplied pressurized fluid up to the maximum pressure, when the pressure relief valve 190 is opened, or up to the maximum volume of the accumulator, when the channel b is brought into communication with the reservoir 120. The pump 110 may then be shut off, until the fluid pressure reaches a lower level or the accumulator level is low, e.g. as given by an estimation of the negative flow from the accumulator, and the pump 110 is started anew.

The control valve 140 may be opened by an appropriate control signal β from the ECU 160. The valve 140 then directs fluid at a certain pressure to the hydraulic cylinder 170 and the clutch 180 is subsequently compressed at least partly. The compression of the clutch 180 makes it possible to transfer torque from a drive shaft to a driven shaft of the vehicle, or to lock-up a differential. When the control valve 140 is closed, the pressurized fluid is drained from the hydraulic cylinder 170 to the reservoir 120, e.g. via the low-pressure side of the accumulator 150 as seen in FIG. 1. The same principle applies if a second valve, a second hydraulic cylinder and a differential brake also are installed in the system.

The accumulator 150 operates as a buffer and makes it possible to deliver high-pressure fluid at a high rate, without initially involving the pump 110. The pump 110 intermittently supplies the accumulator 150 with pressurized fluid and the pump 110 can thus be dimensioned for an average oil supply, since the peak demand will be supplied by the accumulator 150. The pump 110 is thus driven by the average demand, and this can be determined in different ways, e.g. by monitoring the control signals to the PWM valve 140 and by having predetermined tables of leakage through the various components of the hydraulic system.

The hydraulic system 100 for an all-wheel system according to the invention is designed for minimizing the need for sensors and other monitoring equipment to reduce the overall cost of the system. In order to maintain the reliability of the system, a few control features are necessary, and these are given below.

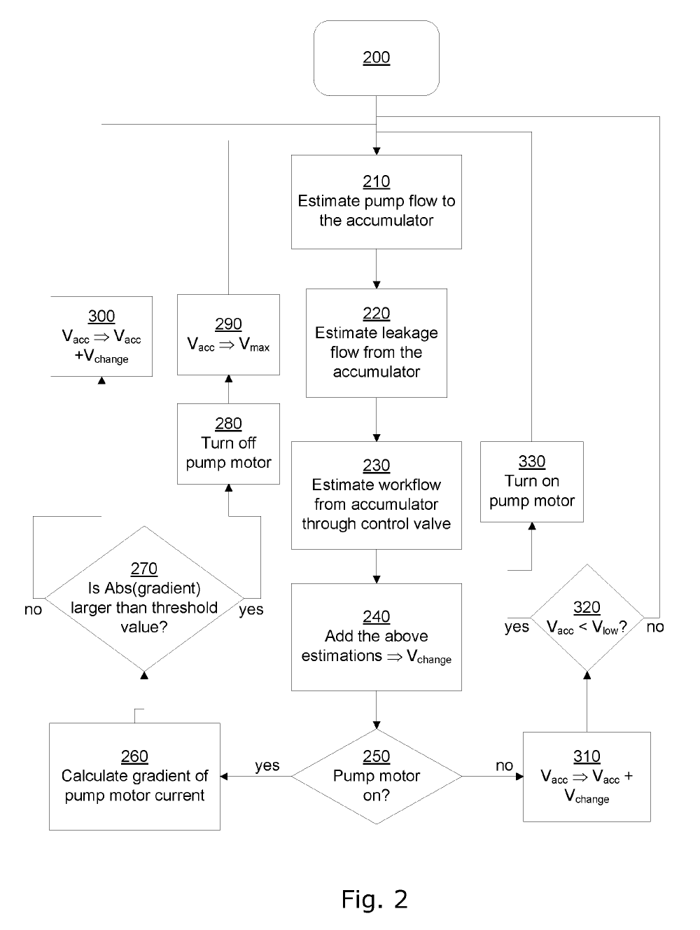

In an embodiment of the present invention, a method applicable to the above-mentioned system is provided, which is suitable for detection of the fill rate of the accumulator 150. The method comprises the following steps, which can be seen in FIG. 2:

210: estimating the oil flow from the oil pump to the accumulator, e.g. given by measurements of current and/or voltage to the electric hydraulic pump 110,

220: estimating nominal system leakage from the accumulator through the control valve 140, the pump 110 etc., e.g. as a predetermined worst-case value, which depends on the hydraulic pressure,

230: estimating hydraulic-fluid work flow from the accumulator through the at least one control valve 140, which e.g. depends on the hydraulic pressure and the elasticity of the coupling 100.

The sum of the above-obtained estimations gives the volume change in the accumulator 150, and this is performed in step 140. If the pump motor is on, the accumulator is being filled. The gradient of the pump motor is calculated in step 260. If the size of this value, Abs(gradient), is above a certain threshold value, the pump motor is turned off since the accumulator is full, as given in step 280. The volume of the accumulator is now the maximum volume, Vmax, as given in step 290. If the accumulator is not full, i.e. the gradient is below a threshold value, the volume in the accumulator is increased in step 300 with the volume change as calculated in step 240. The control method is now repeated by going back to step 210.

If the pump motor is off, the volume of the accumulator is increased with the volume change V_{change} (which in this case is negative), as seen in step 310. If the calculated volume V_{acc} is below a predetermined value V_{low}, the pump is turned on so that the accumulator can be refilled, in step 330. If the accumulator volume is not below said value, V_{low}, do nothing. The sequence is repeated by going back to step 210. The algorithm may be performed in the ECU at a suitable frequency, such as 100 Hz.

For safety reasons, a worst-case leakage flow is optionally used in the algorithm, since this minimizes the risk of emptying the accumulator. This may, however, increase the running frequency of the pump 110, in order to fill the accumulator 150 that is presumed almost empty.

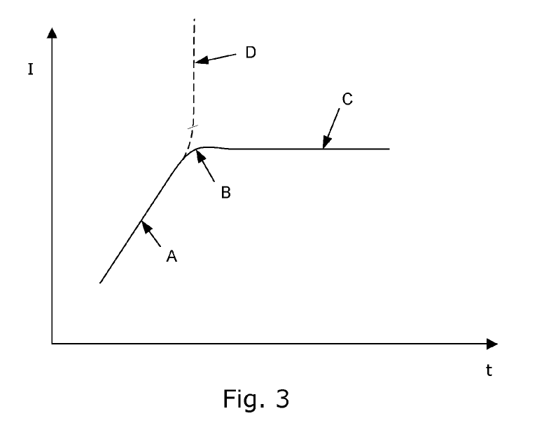

The pump current is monitored, as this is a measure of the load of the pump 110. This drive current of the motor 115 of the electric pump 110 increases with increasing counter-pressure of the pump, see FIG. 3. When the accumulator fills up, the counter-pressure increases, see at A in FIG. 3, until the overflow channel b of the accumulator 150 opens, see at B in FIG. 3. This indicates that the accumulator is full. The overflow leads to a levelling out of the pressure and the drive current of the electric pump hence levels out (see at C in FIG. 3). By monitoring the tangential variations of the electric pump motor current, e.g. by means of an ECU, it is possible to observe when the accumulator is full. If the accumulator is not equipped with an overflow channel b, the piston of the accumulator will reach an end position, and the hydraulic system will become incompressible, rigid. This can also be observed in the drive current of the electric pump 110, but now as a marked increase as can be seen at D in FIG. 3.

The pump voltage is also monitored and this corresponds to the rotational speed of the electric motor 115 and hence the rotational speed of the hydraulic pump 110. The pump flow can hence be estimated by measuring the pump voltage and the pump current and using predetermined models.

The leakage flow through the control valve 140, the pump 110 etc. may be estimated as a simple time dependent flow, but it actually also depends on the fluid pressure in the high-pressure side of the system. The fluid pressure may be estimated by the pump current, as given above, and this is thus used for making more precise predictions of the leakage flow.

By using more of the control signals, the estimation of the fill-rate of the accumulator 150 becomes more and more precise.

The present invention also relates to a computer-readable medium having embodied thereon a computer program for performing the method of the invention, in which case the method steps are represented by code segments.

The method according to the invention will be carried out in a hydraulic system as described above and which is shown in FIG. 1. The heart of the hydraulic system is the accumulator that allows for rapid delivery of high-pressure hydraulic fluid to the control valve(s) of the system. A small pump can be used, since it only has to replenish the accumulator occasionally, and does not have to be sized for the maximum flow in the system.

It is beneficial, though, to minimize the consumption of hydraulic oil in the system since this otherwise leads to frequent running of the hydraulic pump and high energy consumption of the overall system. One way of improving the efficiency of the system is to minimize the flow that is needed to pressurize the hydraulic cylinder. This flow depends on the stroke of the hydraulic cylinder and the elasticity of the system. By designing the hydraulic cylinder for a minimal stroke (volume wise), the only remaining parameter is the elasticity of the system. This depends on the flexibility of the system housing and bolts, on the compressibility of the hydraulic oil, due to therein dissolved or entrained gas, on the compressibility of the sealings and on the compressibility of the clutch disks in the clutch. The last factor, the clutch disks, contributes greatly to the overall elasticity of the system, so this should be minimised.

This can be done by using specific rigid coatings on steel disks, having a coefficient of compressibility that is very low, such as sinter bronze. Such disks, called sintered clutch disks or plates, comprise a steel base and are coated with the sintered coating. Coatings having a similar compressibility are also suitable. The disks can also be formed from one material, having all the features of the steel carrier and the friction material, and also having a low compressibility. The sinter bronze can be CuSn₁₀ or similar composition, which means that about 8-12% of the bronze is tin, about 88-92% copper and other elements can be present in small contents, such as iron, lead, carbon.

1. A method of controlling a hydraulic system for an all-wheel drive system, said hydraulic system comprising an electric hydraulic pump, a control valve for directing hydraulic fluid to a load, and an accumulator in fluid communication with the pump and the valve, said method comprising the steps of
estimating a negative hydraulic-fluid leakage flow out of the accumulator, using a predetermined model,
estimating a negative hydraulic-fluid work flow through the valve, by studying the control signal from an ECU to the control valve and using a predetermined model,
estimating a first positive fluid flow from the pump into the accumulator, from a control signal from the ECU, and
adding the above estimated negative hydraulic-fluid leakage flow, negative hydraulic-fluid work flow and positive fluid flow to a total flow communicating with the accumulator, and
obtaining a value of the volume of the hydraulic fluid in the accumulator from said total flow communicating with the accumulator for controlling an operation mode of said pump.

2. A method according to claim 1, wherein the hydraulic-fluid pressure downstream of the pump is estimated by measuring the electric current supplied to said pump and using table lookup in a table of pump current vs. hydraulic-fluid pressure.

3. A method according to claim 2, wherein the leakage flow through the hydraulic components is calculated from estimated values of the fluid pressure in the high-pressure side of the hydraulic system.

4. A method according to claim 1, wherein the positive fluid flow from the pump is estimated by measuring the pump voltage and/or current from the ECU and using predetermined data on pump performance.

5. A method according to claim 1, wherein a pump current, for driving the electric hydraulic pump, is analyzed in order to detect a marked change in said pump current, which occurs when the pump is pumping to a full accumulator.

6. A method according to claim 5, wherein a reference value of the fluid volume in the accumulator is set to the maximum volume, when the pump current indicates that the accumulator is full.

7. A method according to claim 5, wherein the marked change is a levelling-off of the pump current, as a piston of the accumulator has passed a spillway overflow channel (b) that is incorporated into the accumulator.

8. A method according to claim 5, wherein the marked change is a rapid increase of the pump current, due to the accumulator being full leading to an incompressible system and increased load of the pump.

9. A method according to claim 1, wherein an “on”-signal is sent to the pump based on the above hydraulic-fluid volume change value, when a predetermined low threshold value has been reached.

10. A method according to claim 1, wherein the hydraulic-fluid work flow through the at least one valve is estimated based on estimated hydraulic pressure and predetermined tables of system elasticity.

11. A computer-readable medium having embodied thereon a computer program for processing by a computer for controlling a hydraulic system for an all-wheel drive system, said hydraulic system comprising an electric hydraulic pump, a control valve for directing hydraulic fluid to a load, such as a hydraulic actuator, and an accumulator in fluid communication with the pump and the valve, said program comprising
a first code segment for estimating a negative hydraulic-fluid leakage flow out of the accumulator, such as through the valve and the pump, using a predetermined model,
a second code segment for estimating a negative hydraulic-fluid work flow through the valve, by studying the control signal from an ECU, comprising said computer, to the control valve and using a predetermined model,
a third code segment for estimating a first positive fluid flow from the pump into the accumulator, from a control signal from the ECU, and
a fourth code segment for adding the above estimated negative hydraulic-fluid leakage flow, negative hydraulic-fluid work flow and positive fluid flow to a total flow communicating with the accumulator, and
a fifth code segment for obtaining a value of the volume of the hydraulic fluid in the accumulator from said total flow communicating with the accumulator for controlling an operation mode of said pump.

12. The computer program of claim 11 enabling carrying out of a method of controlling a hydraulic system for an all-wheel drive system, said hydraulic system comprising an electric hydraulic pump, a control valve for directing hydraulic fluid to a load, and an accumulator in fluid communication with the pump and the valve, said method comprising the steps of
estimating a negative hydraulic-fluid leakage flow out of the accumulator, using a predetermined model,
estimating a negative hydraulic-fluid work flow through the valve, by studying the control signal from an ECU to the control valve and using a predetermined model,
estimating a first positive fluid flow from the pump into the accumulator, from a control signal from the ECU, and
adding the above estimated negative hydraulic-fluid leakage flow, negative hydraulic-fluid work flow and positive fluid flow to a total flow communicating with the accumulator, and
obtaining a value of the volume of the hydraulic fluid in the accumulator from said total flow communicating with the accumulator for controlling an operation mode of said pump.

13. A hydraulic system, comprising an electric hydraulic pump, a control valve for directing hydraulic fluid to a load, and an accumulator in fluid communication with the pump and the valve, performing the method according to claim 1.

14. A hydraulic system according to claim 13, wherein the load is a hydraulic cylinder being arranged to operate a clutch, said clutch being provided with at least one clutch disk having a very low overall compressibility, similar to that of sinter bronze.

15. A hydraulic system according to claim 14, wherein the at least one clutch disk comprises a sinter bronze coating.
